(19) United States
(12) Patent Application Publication
(10) Pub. No.: US 2005/0068975 A1
(43) Pub. Date: Mar. 31, 2005

(54) Computer data transport system and method

(76) Inventors: Pierre Colin, Torrance, CA (US); Martin Cameron Watson, Santa Monica, CA (US)

Correspondence Address: John D. Cowart;Teradata Law IP, WHQ-4W, NCR Corporation, 1700 S. Patterson Blvd., Dayton, OH, 45479-0001, US

(21) Appl. No.: 10/675,363

(22) Filed: Sep. 30, 2003

(51) Int. Cl. H04L 12/54

(52) U.S. Cl. 370/428; 370/235; 714/748

(57) ABSTRACT

A method, computer program, and system are disclosed for transferring data. Data packages are transmitted from a plurality of data sources to a first gateway. The data packages are transmitted from the first gateway to a second gateway. The data packages are transmitted from the second gateway to a plurality of data destinations. Acknowledgement messages are transmitted from the data destinations to the second gateway. Pause messages are generated at the second gateway based at least in part on the reception of the acknowledgement messages by the second gateway. The pause messages are transmitted from the second gateway to the first gateway.

### BACKGROUND

Computer systems can store related data across multiple distinct entities. For example, a single database table that includes records that each contain information pertaining to a particular employee can be subdivided for storage. In this case, each storage entity would handle a subset of the total rows of the table. When the user of the system attempts to transfer all the related data from one system in which it is stored across multiple computing entities to another such system, complications can develop. For example, if the data transfer is interrupted, it can be difficult to avoid having to restart the entire transfer. It can also be difficult to track the progress of the data transfer and control the rate at which new data is sent so that no element of the transfer chain is overloaded. In some cases, it is preferable for the packages of data to be received in the same order in which they are sent. It can be difficult to monitor and correct the ordering of packages when there are both multiple sources and multiple destinations.

### SUMMARY

In general, in one aspect, the invention features a system for transferring data. The system includes a plurality of data sources. A first gateway is coupled to the data sources. A second gateway is coupled to the first gateway. A plurality of data destinations are coupled to the second gateway. Data packages are transmitted from a plurality of data sources to a first gateway. The data packages are transmitted from the first gateway to a second gateway. The data packages are transmitted from the second gateway to a plurality of data destinations. Acknowledgement messages are transmitted from the data destinations to the second gateway. Pause messages are generated at the second gateway based at least in part on the reception of the acknowledgement messages by the second gateway. The pause messages are transmitted from the second gateway to the first gateway.

In general, in another aspect, the invention features a computer program for transferring data between computer systems. The program include executable instructions that cause one or more computers to perform the following steps. Data packages are transmitted from a plurality of data sources to a first gateway. The data packages are transmitted from the first gateway to a second gateway. The data packages are transmitted from the second gateway to a plurality of data destinations. Acknowledgement messages are transmitted from the data destinations to the second gateway. Pause messages are generated at the second gateway based at least in part on the reception of the acknowledgement messages by the second gateway. The pause messages are transmitted from the second gateway to the first gateway.

In general, in another aspect, the invention features a method for transferring data between computer systems. Data packages are transmitted from a plurality of data sources to a first gateway. The data packages are transmitted from the first gateway to a second gateway. The data packages are transmitted from the second gateway to a plurality of data destinations. Acknowledgement messages are transmitted from the data destinations to the second gateway. Pause messages are generated at the second gateway based at least in part on the reception of the acknowledgement messages by the second gateway. The pause messages are transmitted from the second gateway to the first gateway.

In one implementation, the system architecture supports a high degree of parallelism for maximum throughput with sending and receiving tasks running concurrently with data transport between computer complexes. In one implementation, end-to-end acknowledgement messages from receiving tasks to sending tasks are not required. In one implementation, the architecture can be scaled by adding additional gateways and preserving ordering. In one implementation, shared memory is not required.

### BRIEF DESCRIPTION OF THE DRAWINGS

FIG. 1 is a block diagram of a node of a parallel processing database system.

FIG. 2 is a block diagram of a system for transferring data.

FIG. 3 is a flow chart of one method for transferring data.

FIG. 4 is a flow chart of one method for multiple data sources in a first computer complex to transmit data packages.

FIG. 5 is a flow chart of one method for handling the data packages at a first transport gateway.

FIG. 6 is a flow chart of one method for handling the data packages at a second transport gateway.

FIG. 7 is a flow chart of one method for receiving the data packages at multiple data destinations.

FIG. 8 is a flow chart of one method for terminating data transfer.

### DETAILED DESCRIPTION

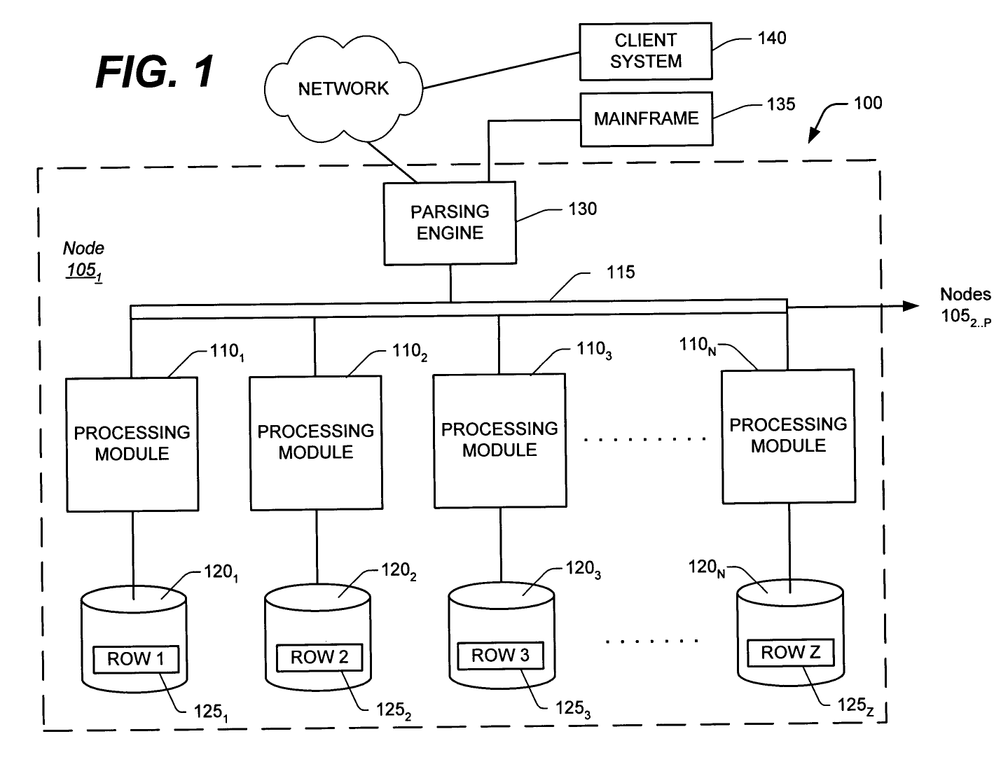

The data transfer techniques disclosed herein have particular application, but are not limited, to large databases that might contain many millions or billions of records managed by a database system (“DBS”) 100, such as a Teradata Active Data Warehousing System available from NCR Corporation. FIG. 1 shows a sample architecture for one node 105₁ of the DBS 100. The DBS node 105₁ includes one or more processing modules 110_{1 . . . N}, connected by a network 115, that manage the storage and retrieval of data in data-storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors.

For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The DBS may include multiple nodes 105_{2 . . . N} in addition to the illustrated node 105₁, connected by extending the network 115.

The system stores data in one or more tables in the data-storage facilities 120_{1 . . . N}. The rows 125_{1 . . . Z} of the tables are stored across multiple data-storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBS 100 usually receives queries and commands to build tables in a standard format, such as SQL.

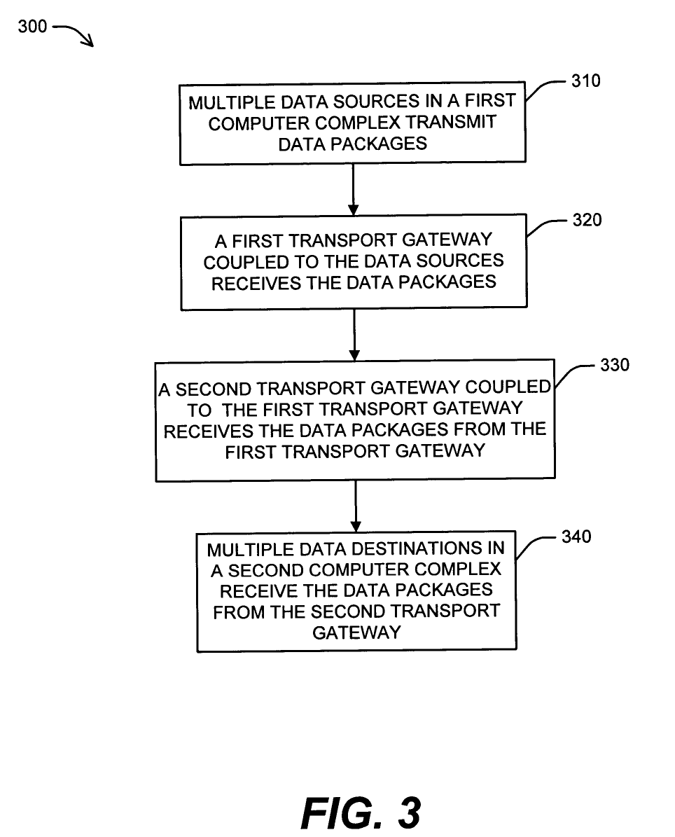

In one implementation, the rows 125_{1 . . . Z} are distributed across the data-storage facilities 120_{1 . . . N} by the parsing engine 130 in accordance with their primary index. The primary index defines the columns of the rows that are used for calculating a hash value. See discussion of FIG. 3 below for an example of a primary index. The function that produces the hash value from the values in the columns specified by the primary index is called the hash function. Some portion, possibly the entirety, of the hash value is designated a “hash bucket”. The hash buckets are assigned to data-storage facilities 120_{1 . . . N} and associated processing modules 110_{1 . . . N} by a hash bucket map. The characteristics of the columns chosen for the primary index determine how evenly the rows are distributed.

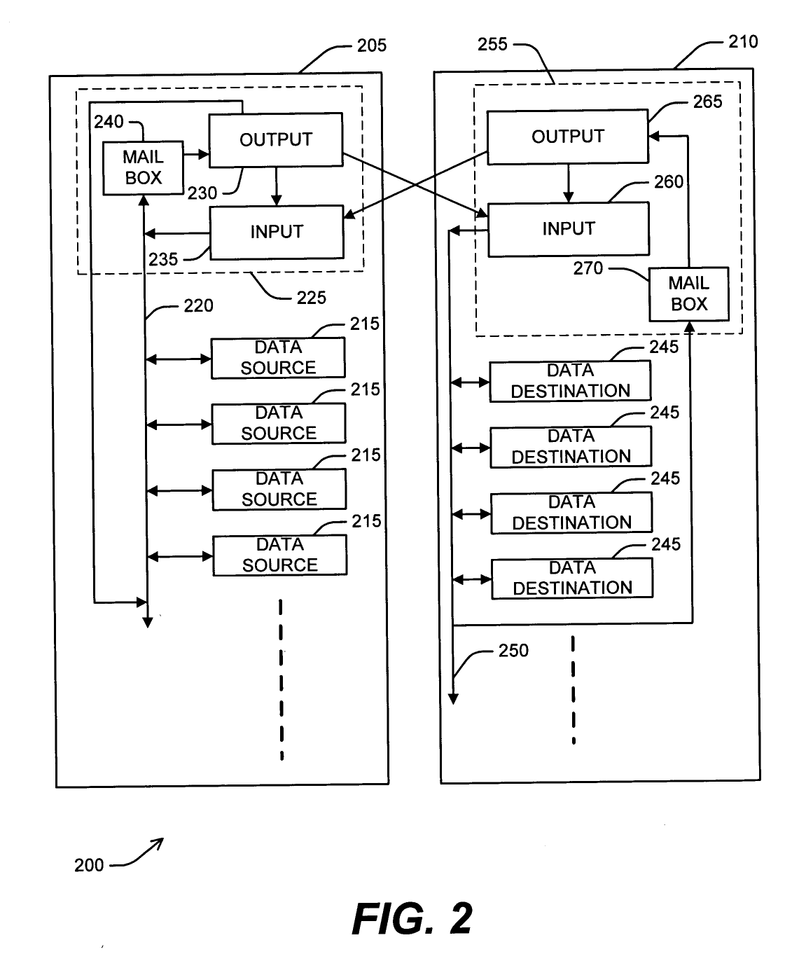

FIG. 2 shows a system for transferring data 200. A first computer complex 205 is coupled to transfer data to a second computer complex 210. The first computer complex 205 includes a plurality of data sources 215. A sending task can be created on each of the data sources 215. Each of the data sources 215 is capable of communicating with an internal network 220. In one implementation the data sources 215 are capable of both sending and receiving data over the network 220. The network 220 is also coupled to a first transport gateway 225. The gateway 225 includes an output task 230, and input task 235 and a mailbox 240. The output task 230 is capable of reading messages and data packages stored on the mailbox 240. The output task 230 can also communicate with the network 220 and the input task 235. The input task 235 can communicate with the network 220. Both the output task 230 and the input task 235 are coupled to the second computer complex 210. The output task 230 is coupled to send data and the input task 235 is coupled to receive data. In one implementation, the computer complexes 205, 210 are coupled by one or more broadband communication paths that support TCP/IP sockets. While the gateway 225 is shown in the same computer complex 205 as the data sources 215 in FIG. 1, in another implementation those elements might be located in different computer complexes.

The second computer complex 210 includes a plurality of data destinations 245. A receiving task can be created on each of the data destinations 245. Each of the data destinations 245 is capable of communicating with an internal network 250. In one implementation the data destinations 245 are capable of both sending and receiving data over the network 250. The network 250 is also coupled to a second transport gateway 255. The gateway 255 includes an input task 260, and output task 265 and a mailbox 270. The output task 265 is capable of reading messages and data packages stored on the mailbox 270. The output task 265 can also communicate with the input task 260. The input task 260 can communicate with the network 250. Both the output task 265 and the input task 270 are coupled to the first computer complex 205. The output task 265 is coupled to send data to the input task 235 of the first computer complex 205. The input task 260 is coupled to receive data from the output task 230 of the first computer complex 205. While the gateway 255 is shown in the same computer complex 210 as the data destinations 245 in FIG. 1, in another implementation those elements might be located in different computer complexes.

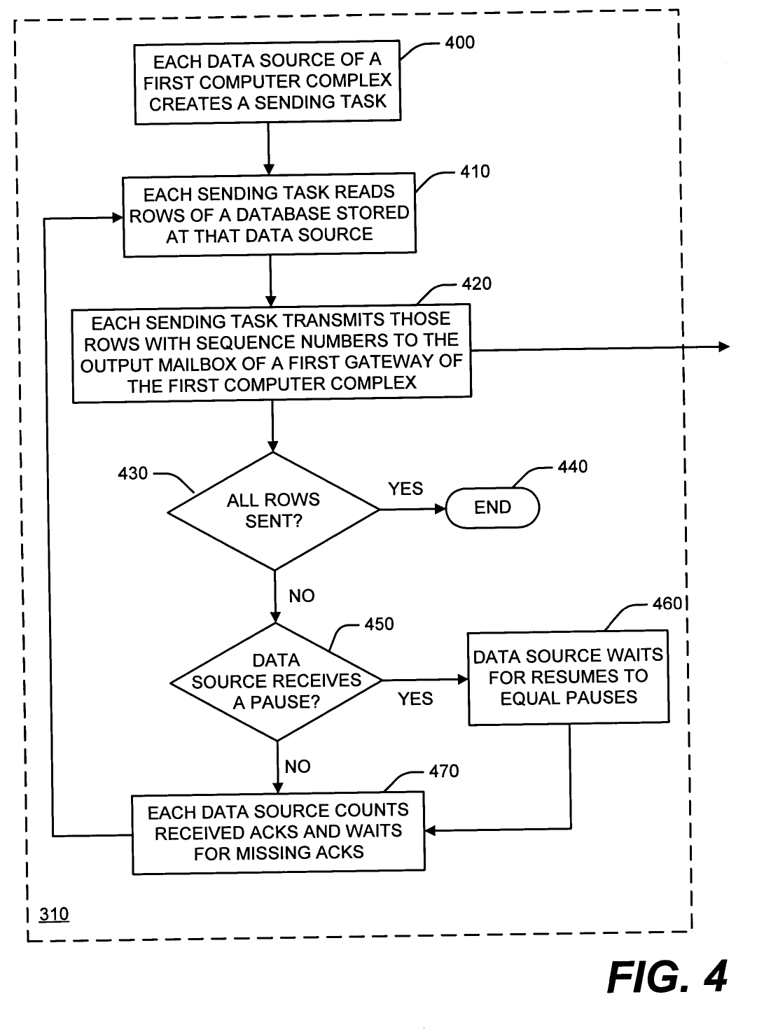

FIG. 3 shows a flow chart of one method for transferring data 300. The method includes four steps that can be implemented in a number of different ways. FIGS. 4-7 each illustrate just one possible implementation. The data is transferred 310 in data packages that are transmitted by multiple data sources 215 in a first computer complex 205. A first transport gateway 225 that is coupled to the data sources 215 receives the data packages 320. A second transport gateway 255 that is coupled to the first transport gateway 225 receives the data packages 330. The second transport gateway 340 then forwards the data packages 340 to multiple data destinations 245 in a second computer complex 210.

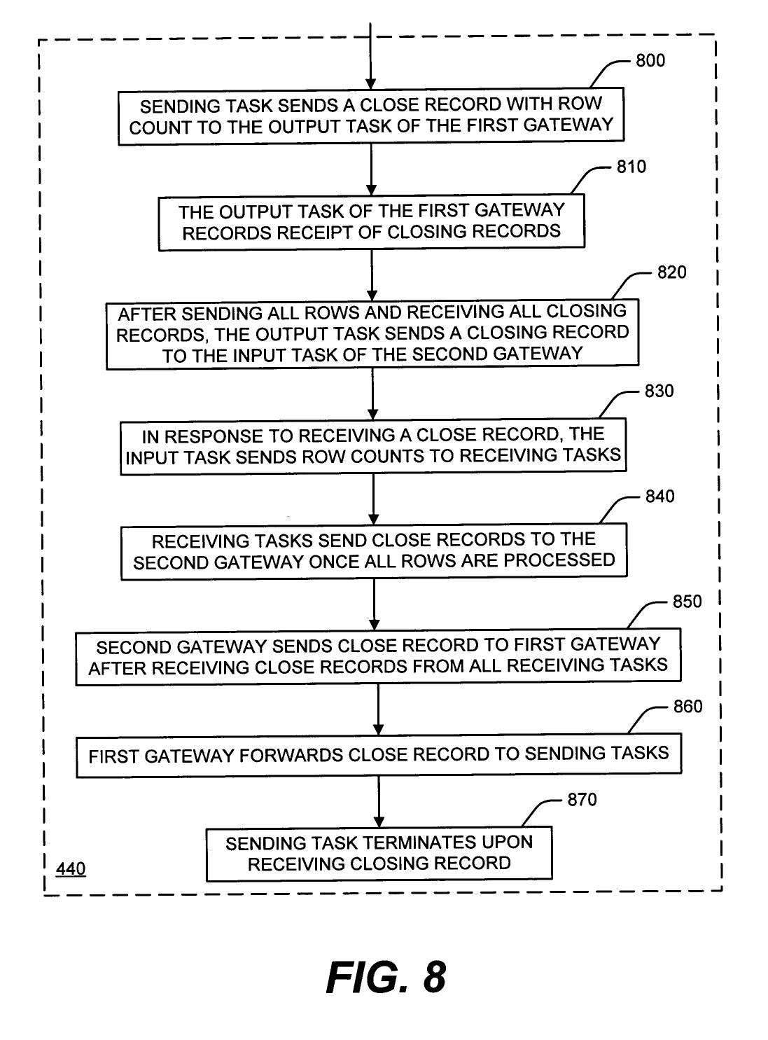

FIG. 4 flow chart of one method for multiple data sources in a first computer complex to transmit data packages 310. Each data source 215 of the first computer complex 205 creates a sending task 400. Those sending task read rows of a database stored at the data source 410. In another implementation, the data packages are not database rows. Those rows are transmitted 420 with sequence numbers to the output mailbox 240 of the gateway 225. In one implementation, the sequence numbers are independent between data sources. In one implementation, data sources send rows to multiple gateways with independent sequence numbers for each gateway. In another implementation, rows are not transmitted with sequence numbers. Once all rows for a particular data source are sent 430, a termination sequence 440 can be initiated. One implementation of a termination sequence is illustrated in FIG. 8. If a data source receives a pause 450, it will wait for receipt of a resume such that the received resume equals the received pauses 460. In one implementation, the data source includes a counter for acknowledgement messages, also called acks, and will delay sending rows where the numbers of acks received trails the number of acks expected by a particular amount 470. For example, in one implementation, an ack could be expected for every four rows or every eight rows and a delay could be instituted when more than one expected ack has not been received. If neither a pause record nor a lack of acks requires a pause, rows continue to be read 410.

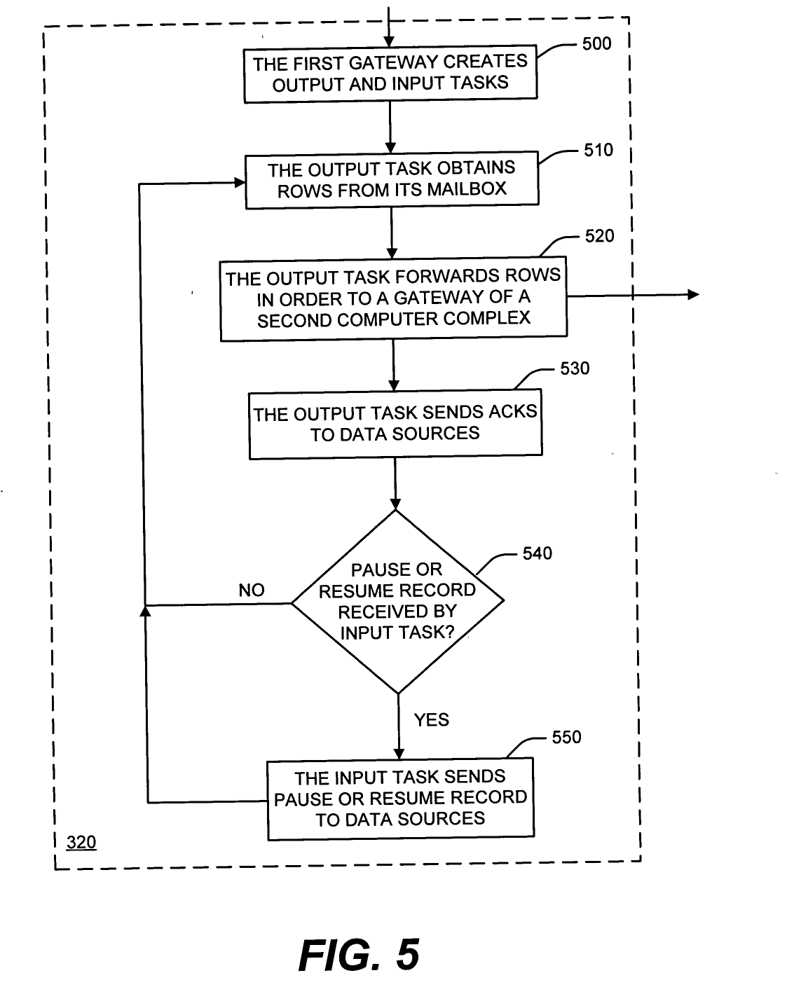

FIG. 5 is a flow chart of one method for handling the data packages at a first transport gateway 320. The gateway 225 creates output 230 and input 235 tasks 500. The output task 230 obtains rows from the gateway mailbox 510. The output task 230 forwards rows in order to a gateway 255 of a second computer complex 520. In one implementation, the output task 230 determines whether rows arrive out of order from a particular data source based on the sequence numbers that are added by that data source. Rows that arrive out of order are queued until rows are obtained from the gateway mailbox allowing transmission in order. As the output task 230 obtains rows from the mailbox 240 it can use the network 220 to send acks to data sources 530. In one implementation, the output task 230 can send an ack for each 4 or 8 rows received. In one implementation, acks are only sent for rows received in order of the sequence numbers. If a pause or resume record is received by the input task 540, the input task sends the record to the data sources 550. In one implementation, the output task 230 continues to transmit rows obtained from the mailbox regardless of the receipt of a pause record.

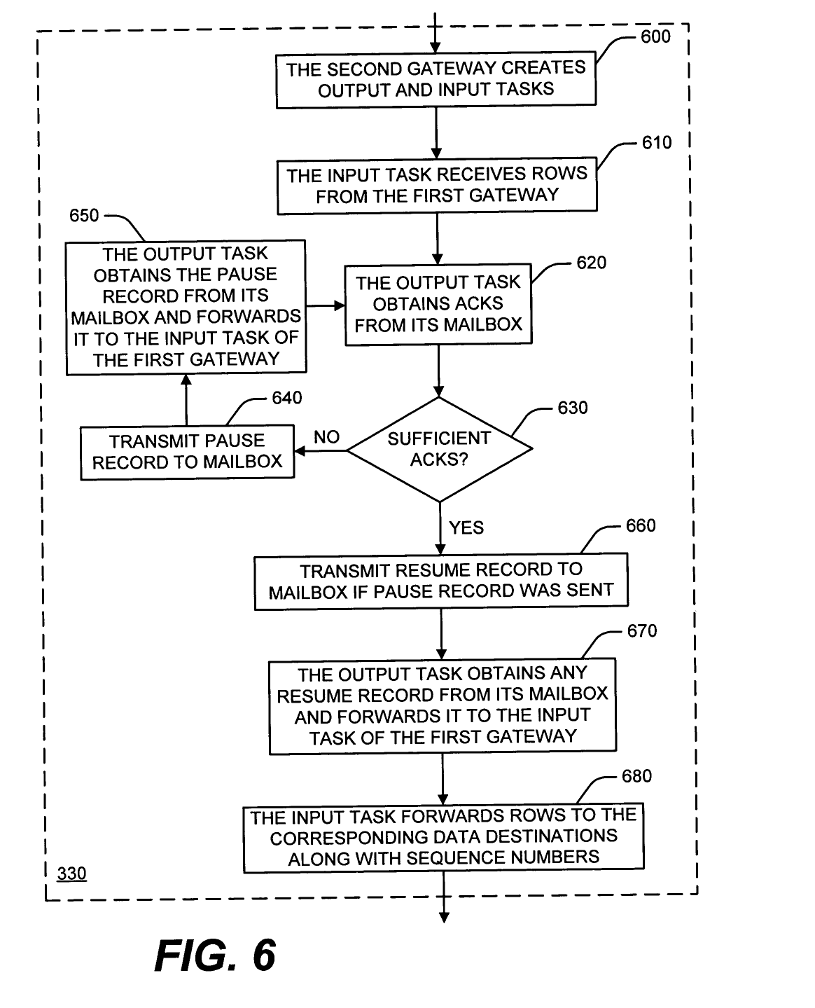

FIG. 6 is a flow chart of one method for handling the data packages at a second transport gateway 330. The second gateway 255 creates output 265 and input 260 tasks 600. The input task 260 receives rows from the first gateway 610. The output task 265 obtains acks from the data destinations 245 from its mail box 620. In one implementation, the output task sends the acks to the input task so that the context can be maintained by the input task. If there are not sufficient acks for a particular data destination 630, the input task uses the internal network to place a pause record in the mail box 640. The output task obtains the pause record and forwards it to the input task of the first gateway 650. If there are sufficient acks 630 and a pause record was previously sent, a resume record will be sent to the mail box by the input task 660. The output task obtains any resume record in the mail box and forwards them to the input task of the first gateway 670. The input task forward rows with sequence numbers to the corresponding data destinations using the internal network 680. In one implementation, the sequence numbers are generated by the input task on a per data destination basis. In another implementation, sequence numbers are not used.

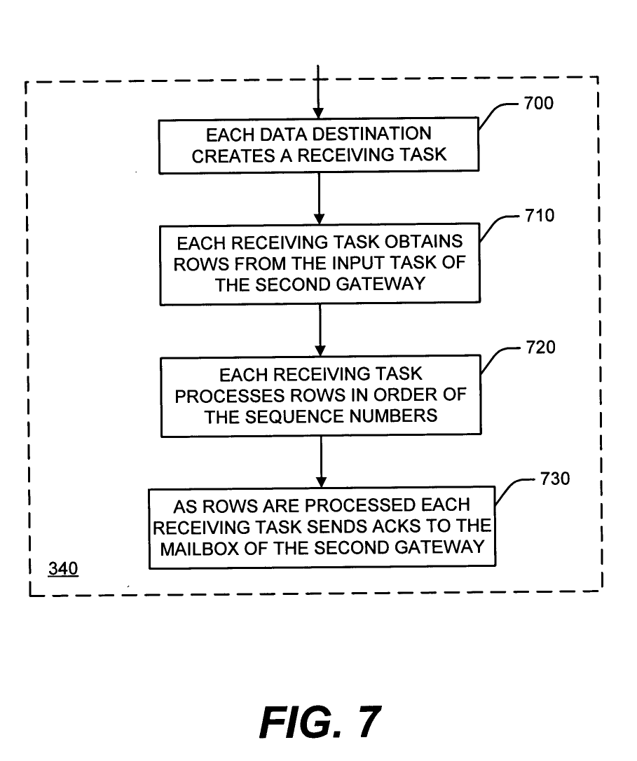

FIG. 7 is a flow chart of one method for receiving the data packages at multiple data destinations 340. Each data destination 245 creates a receiving task 700. Each receiving task receives rows from the input task of the second gateway over the internal network 710. The receiving tasks processes the rows that are received 720. In one implementation, the rows are entered into a new table. In another implementation, the rows are added to a table that existed before the data transfer was initiated. In one implementation, the rows are accompanied by sequence numbers and are only processed in sequence number order. The data destinations queue rows that arrive out of order. In one implementation, multiple gateways are sending rows to a data destination and that data destination has separate queues for each gateway. As rows are processed, each receiving task sends acks to the mailbox of the second gateway 730. In one implementation, the acks are sent after processing of a particular number of rows, e.g., 4 or 8 rows.

FIG. 8 is a flow chart of one method for terminating data transfer 440. After sending the last row, each sending task sends a close record including the number of rows sent to the output task of the first gateway 800. The output task records receipt of the closing records 810. Once closing records have been received from all the data sources and the rows have all been send to the second computer complex, the output task sends a closing record to the input task of the second gateway 820. In one implementation, that closing record includes an overall row count. In another implementation, it includes a row count by data source. The input task sends row counts to the receiving task for each data destination after receiving the closing record from the output task and sending all received rows 830. Once all the rows are processed in a data destination, the count is checked and a close record is sent to the gateway on a successful check 840. After receiving close records from all receiving tasks, the second gateway sends a close record to the first gateway 850. The first gateway forwards the close record to the data sources 860. The sending tasks terminate upon receiving the close record 870. In one implementation, the termination sequence establishes that all receiving tasks have processed all rows from all sending tasks.

The foregoing description of the implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for transferring data between computer systems, comprising the steps of:
(a) transmitting data packages from a plurality of data sources in a first computer network to a first gateway;
(b) transmitting the data packages from the first gateway to a second gateway;
(c) transmitting the data packages from the second gateway to a plurality of data destinations in a second computer network;
(d) transmitting acknowledgement messages from the data destinations to the second gateway;
(e) generating pause messages at the second gateway based at least in part on the reception of acknowledgement messages by the second gateway; and
(f) transmitting the pause messages from the second gateway to the first gateway.

2. The method of claim 1 where the first gateway includes a mailbox and an output task, the data packages are transmitted to the mailbox in step (a), and the output task is capable of retrieving data packages stored in the mailbox.

3. The method of claim 1 further comprising the step of:
(g) transmitting the pause messages from the first gateway to the plurality of data sources.

4. The method of claim 1 where step (a) is performed by a plurality of sending tasks created by the data sources.

5. The method of claim 1 further comprising the steps of:
(g) adding sequence identifiers to the data packages in step (a);
(h) checking the sequence identifiers added in step (g) at the first gateway;
(i) adding sequence identifiers to the data packages in step (c); and
(j) checking the sequence identifiers added in step (i) at the data destinations.

6. The method of claim 1 where the first gateway includes an input task and an output task, the second gateway includes an input task and an output task, step (b) is performed by the output task of the first gateway, steps (c) and (e) are performed by the input task of the second gateway, and step (f) comprises transmitting the pause messages from the output task of the second gateway to the input task of the first gateway.

7. The method of claim 1, further comprising the steps of:
(g) transmitting acknowledgement messages from the first gateway to the data sources; and
(h) counting the acknowledgement messages received at each data source.

8. The method of claim 1, further comprising the steps of:
(g) sending messages with data package transfer information from the data sources to the first gateway;
(h) sending a message with the data package transfer information from the first gateway to the second gateway;
(i) sending messages with the data package transfer information from the second gateway to the data destinations; and
(j) checking the data package transfer information at the data destinations.

9. A computer program, stored on a tangible storage medium, for transferring data between computer systems, the program including executable instructions that cause one or more computers to:
(a) transmit data packages from a plurality of data sources in a first computer network to a first gateway;
(b) transmit the data packages from the first gateway to a second gateway;
(c) transmit the data packages from the second gateway to a plurality of data destinations in a second computer network;
(d) transmit acknowledgement messages from the data destinations to the second gateway;
(e) generate pause messages at the second gateway based at least in part on the reception of acknowledgement messages by the second gateway; and
(f) transmit the pause messages from the second gateway to the first gateway.

10. The computer program of claim 9 where the first gateway includes a mailbox and an output task, the data packages are transmitted to the mailbox in step (a), and the output task is capable of retrieving data packages stored in the mailbox.

11. The computer program of claim 9 where the executable instructions further cause the one or more computers to:
(g) transmit the pause messages from the first gateway to the plurality of data sources.

12. The computer program of claim 9 where step (a) is performed by a plurality of sending tasks created by the data sources.

13. The computer program of claim 9 where the executable instructions further cause the one or more computers to:
(g) add sequence identifiers to the data packages in step (a);
(h) check the sequence identifiers added in step (g) at the first gateway;
(i) add sequence identifiers to the data packages in step (c); and
(j) check the sequence identifiers added in step (i) at the data destinations.

14. The computer program of claim 9 where the first gateway includes an input task and an output task, the second gateway includes an input task and an output task, step (b) is performed by the output task of the first gateway, steps (c) and (e) are performed by the input task of the second gateway, and step (f) comprises transmitting the pause messages from the output task of the second gateway to the input task of the first gateway.

15. The computer program of claim 9 where the executable instructions further cause the one or more computers to:
(g) transmit acknowledgement messages from the first gateway to the data sources; and
(h) count the acknowledgement messages received at each data source.

16. The computer program of claim 9 where the executable instructions further cause the one or more computers to:
(g) send messages with data package transfer information from the data sources to the first gateway;
(h) send a message with the data package transfer information from the first gateway to the second gateway;
(i) send messages with the data package transfer information from the second gateway to the data destinations; and
(j) check the data package transfer information at the data destinations.

17. A system for storing and transferring data, the system comprising:
a plurality of data sources;
a first gateway coupled to the data sources;
a second gateway coupled to the first gateway; and
a plurality of data destinations coupled to the second gateway;
where:
(a) data packages are transmitted from the plurality of data sources to the first gateway;
(b) the data packages are transmitted from the first gateway to the second gateway;
(c) the data packages are transmitted from the second gateway to the plurality of data destinations;
(d) acknowledgement messages are transmitted from the data destinations to the second gateway;
(e) pause messages are generated at the second gateway based at least in part on the reception of the acknowledgement messages by the second gateway; and
(f) the pause messages are transmitted from the second gateway to the first gateway.

18. The system of claim 17 where the first gateway includes a mailbox and an output task, the data packages are transmitted to the mailbox in step (a), and the output task is capable of retrieving data packages stored in the mailbox.

19. The system of claim 17 where:
(g) the pause messages are transmitted from the first gateway to the plurality of data sources.

20. The system of claim 17 where step (a) is performed by a plurality of sending tasks created by the data sources.

21. The system of claim 17 where:
(g) sequence identifiers are added to the data packages in step (a);
(h) the sequence identifiers added in step (g) are checked at the first gateway;
(i) sequence identifiers are added to the data packages in step (c); and
(j) the sequence identifiers added in step (i) are checked at the data destinations.

22. The system of claim 17 where the first gateway includes an input task and an output task, the second gateway includes an input task and an output task, step (b) is performed by the output task of the first gateway, steps (c) and (e) are performed by the input task of the second gateway, and step (f) comprises transmitting the pause messages from the output task of the second gateway to the input task of the first gateway.

23. The system of claim 17 where:
(g) acknowledgement messages are transmitted from the first gateway to the data sources; and
(h) the acknowledgement messages received at each data source are counted.

24. The system of claim 17 where:
(g) messages with data package transfer information are sent from the data sources to the first gateway;
(h) a message with the data package transfer information is sent from the first gateway to the second gateway;
(i) messages with the data package transfer information are sent from the second gateway to the data destinations; and
(j) the data package transfer information is checked at the data destinations.
